(19) United States
(12) Patent Application Publication
(10) Pub. No.: US 2006/0163014 A1
(43) Pub. Date: Jul. 27, 2006

(54) AUTOMATIC SLACK ADJUSTER WITH SPRING RELEASE SPINDLE

(76) Inventor: Gary Edward Crewson, Orchard Park, NY (US)

Correspondence Address: SIMPSON & SIMPSON, PLLC, 5555 MAIN STREET, WILLIAMSVILLE, NY, 14221-5406, US

(21) Appl. No.: 10/905,946

(22) Filed: Jan. 27, 2005

(51) Int. Cl. F16D 65/56; F16D 65/14

(52) U.S. Cl. 188/196 BA

(57) ABSTRACT

An automatic slack adjuster includes a clutch assembly and a disengaging assembly for disengaging the clutch assembly such that an end of a worm shaft may be freely rotated for adjustment purposes. In a preferred embodiment, the clutch assembly is formed from rotor and coupling structures of the automatic slack adjuster, and the disengaging assembly is a pin that separates the rotor and the coupling. In a preferred embodiment, a spring biased button may be depressed to actuate the pin to cause the separation of the rotor and the coupling thereby allowing an end of the worm shaft to be freely rotated.

### FIELD OF THE INVENTION

The present invention relates generally to automatic slack adjusters for brake operating systems, and more specifically, to an improved automatic slack adjuster including means for disengaging the clutch assembly of a slack adjuster to reduce premature wear.

### BACKGROUND OF THE INVENTION

It is known to provide an automatic slack adjuster for connecting a brake operator to a cam shaft of a vehicle brake system. Such types of automatic slack adjuster are generally described in U.S. Pat. No. 5,350,043 (Crewson et al.), U.S. Pat. No. 5,762,165 (Crewson) and U.S. Pat. No. 6,450,302 (Lyons), which patents are incorporated by reference herein.

When the aforementioned automatic slack adjusters are installed on a braking system, the initial rotatable position of the cam shaft relative to the housing is usually adjusted in order to ensure proper operation of the braking system. Such adjustment is typically performed by rotating a free end of the worm shaft of the automatic slack adjuster with a wrench or like tool. A problem associated with adjusting an automatic slack adjuster in this manner is that the devices typically comprise a one-way clutch assembly. The one-way clutch assemblies usually comprise ratchet teeth disposed on rotor and/or coupling components that maintain engagement with one another by means of bias provided by a compression spring. Consequently, it can be difficult to rotate the free end of the worm shaft because of the high amount of force exerted by the compression spring, which acts on the clutch assembly, i.e., the force applied to the clutch assembly by the spring must be overcome to rotate the free end of the worm shaft. More importantly, however, is the fact that the high amount of force exerted on the clutch assembly causes the ratchet teeth of the clutch assembly to grind against one another when the free end of the worm gear is rotated. Thus, adjustment in this manner results in excessive wear of the ratchet teeth, which ultimately results in the premature wear of the clutch assembly, which thereby reduces the lifespan of the slack adjuster.

What is needed then is an improved automatic slack adjuster that is easily and readily adjusted and which prevents premature wear of the clutch assembly.

### SUMMARY OF THE INVENTION

The present invention broadly comprises an automatic slack adjuster having a disengaging assembly for disengaging the clutch assembly of such device such that a free end of a worm shaft may be freely rotated for adjustment. In a preferred embodiment, the clutch assembly is one-way and formed from ratchet teeth of a rotor and/or a coupling. In a preferred embodiment, the disengaging assembly generally comprises a manually actuated pin that separates the rotor and the coupling from one another such that the free end of a worm shaft of the automatic slack adjuster may be freely rotated. In a preferred embodiment the pin is spring biased.

It is, therefore, an object of the invention to provide an automatic slack adjuster that is readily and easily adjustable.

It is another object of the invention to provide an automatic slack adjuster configured to reduce the wear of clutch assembly components when the automatic slack adjuster is adjusted.

It is, still yet, another object of the invention to provide manually operable means for disengaging clutch assembly of an automatic slack adjuster such that a free end of a worm shaft may be freely rotated.

### BRIEF DESCRIPTION OF THE DRAWINGS

The nature and mode of operation of the present invention will now be more fully described in the following detailed description of the invention in view of the accompanying drawing figures, in which:

FIG. 1 is a side elevation view of an automatic slack adjuster according to the present invention connected to a brake operator of a braking system;

FIG. 2 is an enlarged fragmentary sectional view of an automatic slack adjuster according to the present invention with a portion of its housing removed, which illustrates the disengaging assembly of the present invention in the “rest” position;

FIG. 3 is an enlarged fragmentary sectional view of an automatic slack adjuster according to the present invention with a portion of its housing removed, which illustrates the disengaging assembly of the present invention in the “actuated” position;

FIG. 4 is a sectional view, taken generally along line 4-4 of FIG. 2, which illustrates the disengaging assembly of the present invention in the “rest” position;

FIG. 5 is a sectional view, taken generally along line 5-5 of FIG. 3, which illustrates the disengaging assembly of the present invention in the “actuated” position; and,

FIG. 6 is a top fragmentary view of an automatic slack adjuster according to the present invention illustrating the disengaging assembly in the “rest” position.

### DETAILED DESCRIPTION OF THE INVENTION

At the outset, it should be appreciated that like drawing numbers on different drawing views identify identical structural elements of the invention. It should also be appreciated that while the present invention is described with respect to what is presently considered to be the preferred embodiments, the invention is not limited to the specific embodiments disclosed herein.

Referring now to the figures, as shown in FIG. 1 automatic slack adjuster according to the present invention is generally designated by reference numeral 10 and is shown as being connected to an operator shaft 12 of a known brake operating system via an operator shaft mounted clevis 14 and pivot pin 16 and to a cam shaft 18 of a known vehicle brake system. In this figure it is seen that the outer structures of slack adjuster 10 generally include an elongated housing 20 comprising a first bore adjacent one end for receiving pivot pin 16 and a second bore adjacent an opposite end for rotatably supporting a worm gear 22. Worm gear 22 is suitably keyed to cam shaft 18 for rotation about first axis 26. Slack adjuster 10 is also connected to clevis 14 via link 28, which is slidably supported by housing 20 and has a protruding end pivotally connected to the clevis by a pivot pin 30.

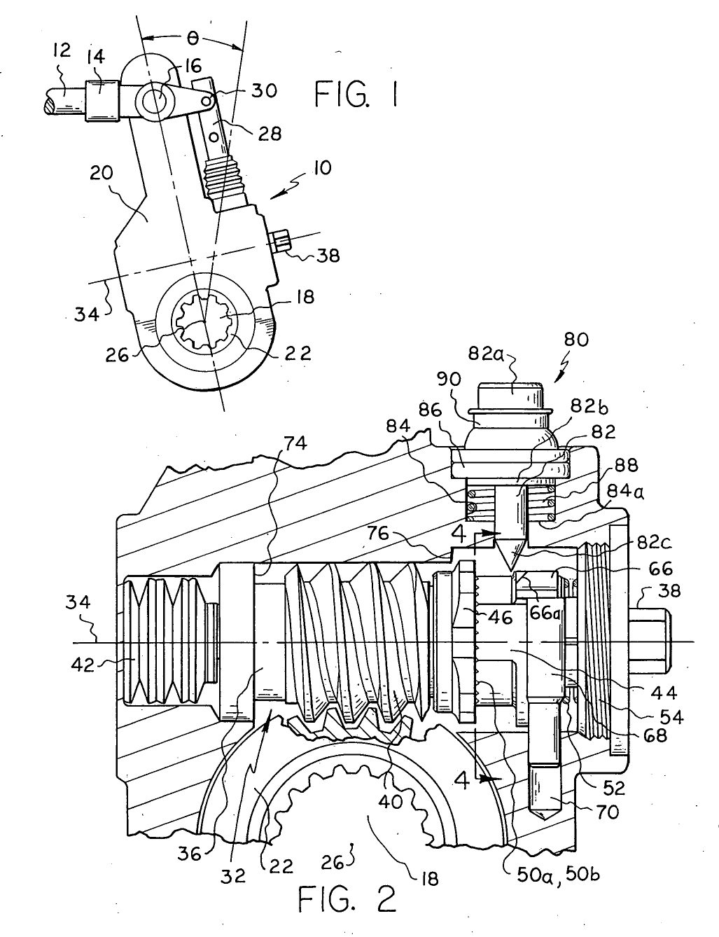

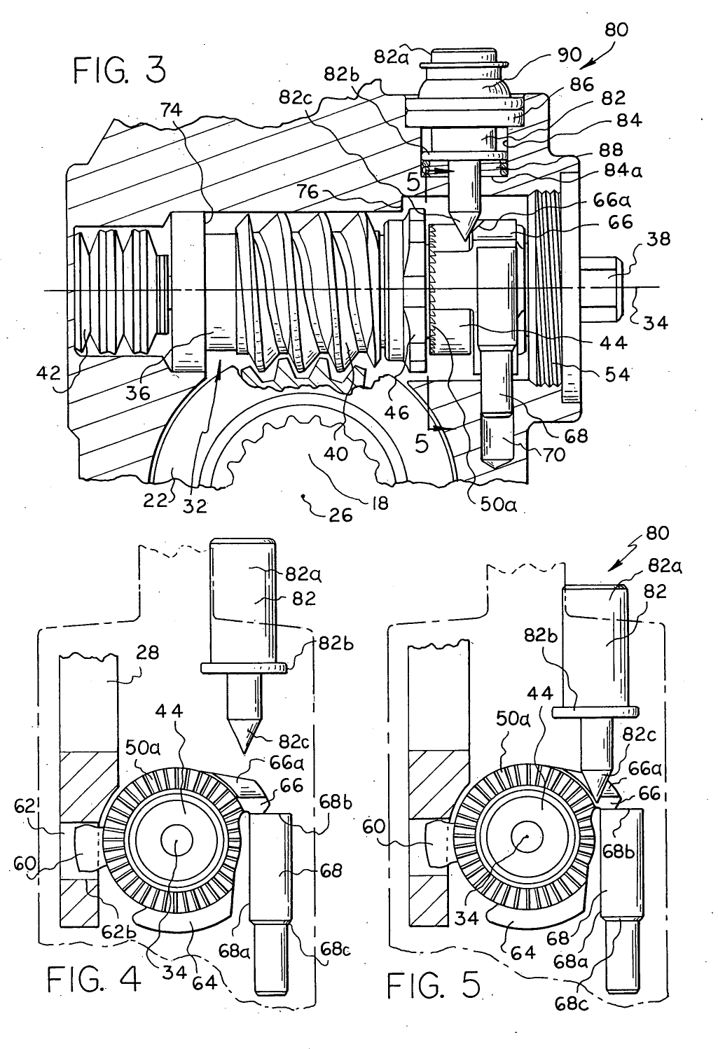

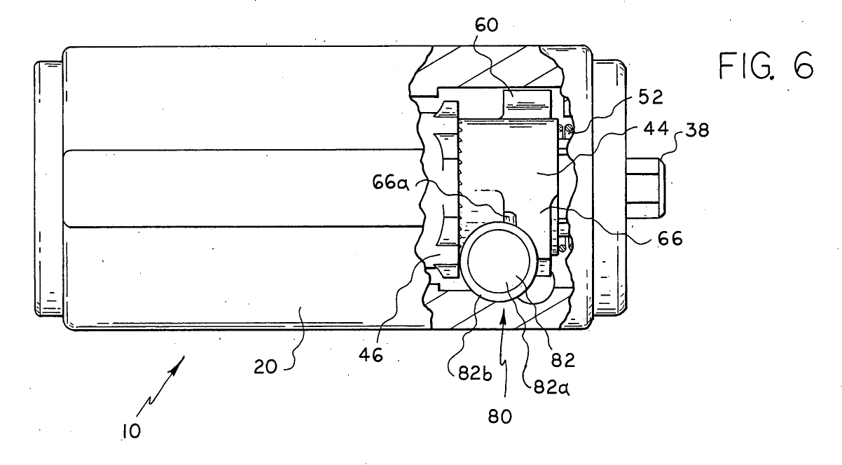

Referring now to FIGS. 2-6, while several of the interior structures of a slack adjuster according to the present invention are described in U.S. Pat. No. 5,350,043, U.S. Pat. No. 5,762,165, and U.S. Pat. No. 6,450,302, a recitation of such structures and their operation is provided for a clear understanding of the invention.

Interior structures of automatic slack adjuster 10 generally comprise worm shaft 32, first compression spring 42, rotor 44, coupling 46, second compression spring 52, member 68, and spring release spindle 80.

Worm shaft 32 generally comprises first end 36 and second end 38 and is arranged for rotational and lateral movement about and along second axis 34. Worm 40 is disposed intermediate the first and second ends and is arranged to engage worm gear 22. First compression spring 42 is provided for engagement with first end 36 of worm shaft 32 and tends to oppose the lateral movement of worm shaft 32 in a direction toward the first end. Second end 38 of worm shaft 32 freely rotatably mounts rotor 44 and coupling 46 via a bearing sleeve (not shown). Rotor 44 is coupled to coupling 46 by a suitable one-way clutch 50, such as may be defined by ratchet teeth 50a and 50b arranged on facing end surfaces of the rotor and coupling, respectively. A second compression spring 52 is arranged between the rotor and end plug 54 for biasing the teeth of rotor 44 into engagement with the teeth of coupling 46. Teeth 50a and 50b are shaped and arranged to permit coupling of the rotor and coupling when rotor 44 is rotated in a first direction, e.g., clockwise when viewed along axis 34 from second end 38, and permits uncoupling of the rotor when it is rotated in a second direction, e.g., counter-clockwise when viewed along axis 34 from second end 38.

Coupling 46 is also releasably connected, or coupled, for rotation with worm shaft 32 by a slip means (not shown), which may be defined by shallow grooves and teeth arranged on facing frusto-conical surfaces of coupling 46 and worm 40. Thus, compression spring 42 tends to bias worm shaft 32 in the direction of second end 38 such that the grooves and teeth of the slip means engage and connect coupling 46 for rotation with the worm shaft. Coupling 46 is also preferably formed with a radially outwardly extending abutment or motion limiting flange 46a.

As illustrated more clearly in FIGS. 4 and 5, rotor 44 is movably coupled to link 28 by providing the rotor with a radially outwardly projecting lug 60 arranged to be loosely received within a recess 62 of the link. Rotor 44 is also provided with radially outwardly projecting first and second abutments 64 and 66, respectively, which are arranged for operable engagement with member 68 supported for reciprocating movement within a recess 70 defined by housing 20 under the control of a return spring (not shown), which is preferably in the form of a coil type compression spring. Abutment 66, preferably, includes beveled portion 66a, whose purpose is explained in more detail below. Preferably, member 68 is in the form of a cylindrically shaped pin having a side surface, which defines a first abutment surface 68a disposed in alignment with the direction of its reciprocating movement, and oppositely facing end surfaces, which define second and third abutment surfaces 68b and 68c, respectively, spaced apart in such direction of movement. First abutment surface 68a is arranged to be engaged by first abutment 64 to define the reference position of rotor 44 shown in FIG. 4, second abutment surface 68b is arranged for engagement by second abutment 66, and third abutment surface 68c is arranged for engagement by a return spring (not shown).

Spring release spindle 80 is provided for manually separating rotor 44 and coupling 46, for example, during installation, removal and/or troubleshooting of the stroke indicator in order to minimize clutch assembly wear. Spring release spindle 80 generally includes pin 82, counter-bore hole 84, annular retaining ring 86, spring 88 and boot 90. Pin 82 is configured for slidable movement within counter-bore hole 84, which extends from the exterior of housing 20 to the inner cavity of the stroke indicator wherein rotor 44 and coupling 46 are housed. Pin 82 comprises button end 82a which protrudes from housing 20 under bias of spring 88, flange portion 82b for retaining the spring and pin within the counter-bore hole, and tapered end 82c for slidably communicating with beveled portion 66a of second abutment 66 of rotor 44. Annular retaining ring 86 is configured to retain pin 82 within counter-bore hole 84 and, preferably, threadably mates with the counter-bore hole. The orifice disposed within the annular retaining ring is sized to allow the button end of the pin to pass therethrough and prevent the flange portion of the pin to pass. Spring 88 is disposed between the lower side of flange portion 82b and abutment wall 84a of the counter-bore hole to bias pin 82 such that the button portion 82a protrudes from housing. Boot 90 is, preferably, provided to prevent dirt and other elements from entering housing 20. Boot 90 may, preferably, be formed from an elastomeric material. While in a preferred embodiment, disengaging assembly comprises pin 82 which may be longitudinally disposed within counter-bore hole 84, the disengaging assembly may be configured to be rotatably or laterally disposed to disengage the rotor and coupling from one another, e.g., by a lever or knob.

The operation of a slack adjuster according to the present invention is generally similar to that described in U.S. Pat. No. 5,350,043, U.S. Pat. No. 5,762,165, and U.S. Pat. No. 6,450,302. In operation, slack adjuster 10 normally assumes an initial position shown in FIG. 1, wherein the brakes of a vehicle are fully released. In this initial position, teeth 50a and 50b of one-way clutch 50 are engaged, and the grooves and teeth of the slip means (not shown) are engaged. Link 28 occupies an initial contracted position within housing 20 and rotor 44 occupies its reference position, generally shown by FIGS. 4 and 5.

Upon application of braking force to the brake operating system, operator shaft 12 is forced to move to the right, as viewed in FIG. 1, and thereby causes housing 20 and worm gear 22 to rotate about first axis 26 through an angle θ until cam shaft 18 has been rotated sufficiently to fully apply the brakes of a vehicle. As an incident to rotation of housing 20 through angle θ, link 28 is partially withdrawn from within housing 20, due to its pivot connection with clevis 14, until it assumes an extended position. As link 28 is extended, lower recess surface 62b first engages lug 60 and then lifts the lug to impart a clockwise directed rotation to rotor 44, as viewed from first end 36 (see FIGS. 4 and 5), until the rotor is moved into an intermediate position coincident with the arrival of the link in its extended position. As rotor 44 is rotated from its reference position into its intermediate position, spring 52 permits the rotor to ratchet relative to coupling 46, and return spring (not shown) is compressed as member 68 is forced to slide within recess 70, due to engagement of second abutment 66 with second abutment surface 68b.

During the whole of the braking operation, worm shaft 32 tends to remain fixed against rotation about second axis 34. Thus, worm gear 22 remains essentially rotationally fixed relative to housing 20, such that both the worm gear and cam shaft 18 are rotated through the angle θ for brake application purposes. As sufficient braking force is applied, worm shaft 32 tends to move towards first side 36 against the bias of spring 42 due to the axial reaction force created between worm gear 22 and worm 40. As long as this braking force is below a certain limit, spring 42 will not yield, but when such force overcomes the preload of the spring, worm shaft 32 will be axially displaced until arrested by suitable means, such as by engagement of worm 40 with annular abutment surface 74. Upon displacement of worm shaft 32 in this manner, grooves and teeth of slip means (not shown) tend to disengage, such that coupling 46 is free to rotate relative to worm shaft 32.

In order to insure complete disengagement of grooves and teeth of the slip means incident to axial displacement of worm shaft 32 against the bias of spring 42, there is provided restraining means in the form of a second abutment surface 76, which is arranged for engagement by flange 46a of coupling 46 and is adapted to limit worm shaft following movement of the coupling toward first end 36 under the bias of spring 52. Alternatively, the above restraining means may be a compression spring, not shown, arranged axially intermediate worm 40 and coupling 46 to effect disengagement of grooves and teeth of slip means upon initiation of displacement of worm shaft 32 against the bias of spring 42. Such compression spring would necessarily exert a greater spring force than spring 52 and a lesser spring force than spring 42. In either arrangement, wear of grooves and teeth of slip means induced by relative rotational movement thereof while in partially engaged condition is alleviated.

Upon release of braking force on the brake operating system, operator shaft 12 is retracted until housing 20 is rotated counterclockwise through angle θ for return to its initial position shown in FIG. 1, and coincident therewith link 28 is forced to return to its initial contracted position. As link 28 moves towards its initial position, return spring (not shown) operating through member 68, biases rotor 44 for rotation in a counterclockwise direction as viewed from first end 36 (see FIGS. 4 and 5), for return to its reference position. The speed of this counterclockwise rotation of rotor 44 is limited by the speed at which link 28 is returned to its initial position, since return spring (not shown) tends to maintain lug 60 in following engagement with link lower surface 62b. Further, during rotation of rotor 44 towards its reference position, coupling 46 is coupled for rotation with the rotor due to the presence of one-way clutch 50. However, coupling 46 remains uncoupled form worm shaft 32, until such time as axial loading of the worm shaft decreases sufficiently to permit compression spring 42 to force the worm shaft to reengage the slip means. If re-engagement of the slip means does not occur until substantially coincident with the return of rotor 44 to its reference position, no rotational movement will be imparted to worm shaft by the rotor during the brake operational cycle, and, thus, no adjustment of the vehicle brakes will occur during such cycle and the brakes will remain in properly adjusted condition. On the other hand, if positive re-engagement of the slip means should occur before return of rotor 44 to its reference position, rotor 44 will be operable to drive worm shaft 32 for rotation in a clockwise direction, as viewed from second end 38, with the result that worm 40 will drive worm gear 22 and thus rotate cam shaft 18 for rotation relative to housing 20 to take up slack existing in the vehicle brake system. After any such slack adjustment, no further rotation of cam shaft 18 relative to housing 20 will occur during subsequent brake operational cycles, until a subsequent slack condition occurs, due for instance to the further wearing away of brake pads incorporated in the vehicle brake system.

Upon installation, replacement and/or troubleshooting of the slack adjuster, it is generally desirable to adjust the device to ensure proper operation. To do so, spring release spindle 80 may be actuated prior to rotating the free end portion of second end 38. Actuating spring release spindle 80 acts to prevent the teeth of rotor 44 and coupling 46 from grinding against one another during adjustment. As illustrated more clearly in FIGS. 2-5, to operate the spring release spindle, button end 82a of pin 82 is depressed to cause tapered end 82c thereof to contact beveled portion 66a of second abutment 66 of rotor 44. When the button end of the pin is further depressed and sufficient force is applied to overcome the bias of spring 52, the rotor is laterally disposed toward second end 38 to thereby cause rotor 44 to disengage from coupling 46. Upon such disengagement, the free end portion of the second end may be freely rotated to adjust the rotational position of the rotor, without causing the teeth of the rotor and/or coupling to grind against one another. Upon completion of the necessary rotational adjustment of the rotor, the pin may be allowed to return to its start position as shown in FIG. 2 such that rotor 44 reengages with coupling 46.

It should be appreciated, however, where insufficient care is exercised to properly adjust the initial rotatable position of cam shaft 18 relative to housing 20, via manipulation of the free end portion of second end 38 of worm shaft 32, the loading applied to the worm shaft, during initial brake operational cycles, may be insufficient to effect axial displacement of the worm shaft, such that rotor 44 will be drivingly coupled to cam shaft 18 during all or a substantial portion of rotational movement of the rotor from its intermediate position towards its reference position. If this should occur, the force of return spring may be insufficient to timely initiate driven rotation of rotor 44 for return to its reference position in the manner contemplated for the case where only slight adjustment of slack is required incident to normal brake usage. This potential problem is elevated by shaping first abutment 64 such that it is arranged to underlie the inner or lower end surface of link 28, when the link is disposed in its extended position and rotor 44 is disposed in an intermediate position. Thus, when return movement of link 28 is initiated, its inner end surface will engage with abutment 64 and positively initiate return rotational movement of rotor 44 at least until lug 60 is fully inserted within slot 62 and arranged for underlying driven engagement by an upper end of the slot, if required. Depending on the degree of initial slack existing in the system, one or more brake operational cycles may be required before cam shaft 18 is properly positioned relative to housing 20, but thereafter, the operational cycle of the present brake adjuster will be as described above.

Thus, it is seen that the objects of the present invention are efficiently obtained. It should be appreciated, however, that while the construction specifically disclosed above is preferred, it is contemplated that various modifications may be made without departing from the spirit and scope of the present invention. For example, the invention could be modified such that the coupling, as opposed to the rotor, is disposed for disengaging the clutch assembly.

What is claimed is:

1. An automatic slack adjuster comprising:
a clutch assembly; and,
a disengaging assembly for disengaging said clutch assembly such that an end of a worm shaft of said automatic slack adjuster is freely rotatable.

2. The automatic slack adjuster of claim 1 wherein said clutch assembly is formed from a rotor and a coupling.

3. The automatic slack adjuster of claim 2 wherein said clutch assembly comprises ratchet teeth to engage said rotor with said coupling.

4. The automatic slack adjuster of claim 3 wherein at least one of said rotor and said coupling are disposed by a bias.

5. The automatic slack adjuster of claim 4 wherein said bias is provided by at least one spring.

6. The automatic slack adjuster of claim 2 wherein said disengaging assembly separates said rotor and said coupling.

7. The automatic slack adjuster of claim 6 wherein said disengaging assembly comprises a member selected from the group consisting of pin and lever.

8. The automatic slack adjuster of claim 7 wherein said disengaging assembly is spring biased.

9. The automatic slack adjuster of claim 8 wherein said disengaging assembly is manually actuated.

10. An automatic slack adjuster comprising:
a clutch assembly comprising a rotor and a coupling; and
a disengaging assembly for disengaging said rotor and said coupling such that an end of a worm shaft of said automatic slack adjuster is freely rotatable.

11. The automatic slack adjuster of claim 10 wherein said clutch assembly comprises ratchet teeth for engaging said rotor with said coupling.

12. The automatic slack adjuster of claim 11 wherein at least one of said rotor and said coupling are disposed by a bias.

13. The automatic slack adjuster of claim 12 wherein said bias is provided by at least one spring.

14. The automatic slack adjuster of claim 10 wherein said disengaging assembly separates said rotor and said coupling.

15. The automatic slack adjuster of claim 10 wherein said disengaging assembly comprises a member selected from the group consisting of pin and lever.

16. The automatic slack adjuster of claim 15 wherein said pin and lever is spring biased.

17. The automatic slack adjuster of claim 16 wherein said disengaging assembly is manually actuated.

18. A method for adjusting an automatic slack adjuster comprising:
disengaging a clutch assembly of a worm shaft of said automatic slack adjuster such that said worm shaft is freely rotatable; and,
rotating an end of said worm shaft.

19. The method of claim 18 wherein said clutch assembly comprises a rotor and a coupling and said disengaging is accomplished by a disengaging assembly that separates said rotor and said coupling from one another prior to rotating said free end of said worm shaft.

20. The method of claim 19 wherein separating said rotor and said coupling is accomplished by actuating said disengaging assembly to assert a force upon said disengaging assembly to thereby dispose said disengaging assembly between said rotor and said coupling.
